(19) United States
(12) Patent Application Publication
(10) Pub. No.: US 2005/0177418 A1
(43) Pub. Date: Aug. 11, 2005

(54) Transaction system

(76) Inventor: Stephen Arthur Michener, Glen Iris (AU)

Correspondence Address: SUGHRUE MION, PLLC, 2100 PENNSYLVANIA AVENUE, N.W., SUITE 800, WASHINGTON, DC, 20037, US

(21) Appl. No.: 10/499,195

(22) PCT Filed: Dec. 18, 2002
(86) PCT No.: PCT/AU02/01729

(30) Foreign Application Priority Data
Dec. 18, 2001 (AU) PR 9590

(51) Int. Cl. G06F 17/60

(52) U.S. Cl. 705/14

(57) ABSTRACT

A transaction system, including a server for receiving bids for coupons at prices less than a predetermined value, each coupon representing an outcome of an event having more than two possible outcomes, the coupon having the predetermined value if that outcome occurs and no value if that outcome does not occur, and a transaction engine for generating bid data representing buy and sell bids for and against each outcome of the event on the basis of the received bids, and determining a match between received bids on the basis of the generated bid data.

### FIELD OF THE INVENTION

The present invention relates to a transaction method and system.

### BACKGROUND

Most systems for handling betting transactions adopt a methodology that has applied to betting for centuries. Whilst the event bet upon may vary considerably, the transaction has traditionally involved one party placing a bet for an event to occur with another party or system operator and paying a certain amount to place the bet. The party that accepts the bet retains the amount until the event is determined, and if the event occurs the betting party receives a winning amount that depends on the odds given for the event occurring. The accepting party retains the original amount if the event does not occur. The odds that determine the winning amount may be fixed at the time of the transaction, or determined immediately prior to determination or resolution of the event by the accepting party, if the accepting party is, for example, a system operator.

Systems that operate as described above generally do not allow a betting party any further flexibility with regard to the transaction. For example, normally the betting party cannot determine the odds, nor is any subsequent trading of the transaction allowed. The transaction is also normally restricted to being between a betting party and a system operator for such systems.

It is desired to provide an improved transaction method and system that alleviate one or more problems of the prior art, or at least provide a useful alternative.

### SUMMARY OF THE INVENTION

In accordance with the present invention, there is provided a transaction method, including.
receiving bids for coupons at prices less than a predetermined value, each coupon representing an outcome of an event having more than two outcomes, the coupon having said predetermined value if said outcome occurs and no value if said outcome does not occur,
generating bid data representing buy and sell bids for and against each outcome of said event on the basis of the received bids; and
determining a match between received bids on the basis of the generated bid data.

The present invention also provides a transaction method, including:
receiving a bid for at least one coupon at a price less than a predetermined value, said coupon representing an outcome of an event having more than two outcomes and having a predetermined value if said outcome occurs and no value if said outcome does not occur; and
attempting to match said bid with bids for coupons representing outcomes of said event other than said outcome.

The present invention also provides a transaction method, including:
maintaining lists of buy and sell bids for and against outcomes of an event having more than two outcomes;
receiving a bid for at least one coupon at a price less than a predetermined value, said coupon representing an outcome of said event and having a predetermined value if said outcome occurs and no value if said outcome does not occur; and
matching said bid with bids of said lists representing outcomes other than said outcome.

The present invention also provides a transaction method for processing bids for coupons at prices less than a predetermined value, each coupon representing an outcome of an event having more than two outcomes, the coupon having said predetermined value if said outcome occurs and no value if said outcome does not occur.

The present invention also provides a transaction system including means for processing bids for coupons at prices less than a predetermined value, each coupon representing an outcome of an event having more than two outcomes, the coupon having said predetermined value if said outcome occurs and no value if said outcome does not occur.

The present invention also provides a transaction system, including:
a server for receiving bids for coupons at prices less than a predetermined value, each coupon representing an outcome of an event having more than two outcomes, the coupon having a predetermined value if said outcome occurs and no value if said outcome does not occur,
a transaction engine for generating bid data representing buy and sell bids for and against each outcome of said event on the basis of the received bids, and determining a match between received bids on the basis of the generated bid data.

The present invention also provides a transaction system for establishing a trading market for coupons representing outcomes for an event having more than two outcomes.

### BRIEF DESCRIPTION OF THE DRAWINGS

Preferred embodiments of the present invention are hereinafter described, by way of example only, with reference to the accompanying drawings, wherein:

FIG. 1 is a block diagram of a preferred embodiment of a transaction system connected to user equipment via a communications network;

FIG. 2 is a state diagram of an event object of the transaction system;

FIG. 3 is a schematic diagram of lists in an engine server of the transaction system;

FIG. 4 is a flow diagram of a bid server process of the transaction system;

FIG. 5 is a flow diagram of a request queuing process of the transaction system;

FIG. 6 is a flow diagram of a bid matching process of the transaction system; and

FIGS. 7 and 8 are diagrams illustrating the bid matching process.

### DETAILED DESCRIPTION OF THE PREFERRED EMBODIMENTS

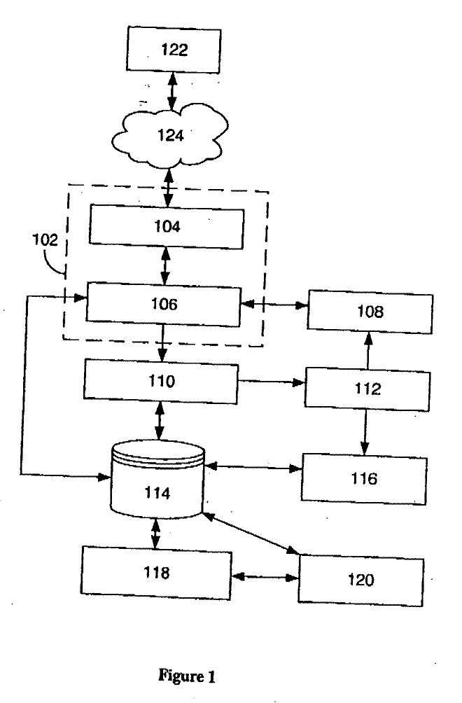

As shown in FIG. 1, a transaction system includes a web server module 104, a web services provider (WSP) module 106, a bid display server 108, a bid server 110, an engine server 112, a database server 114, a coupon server 116, a payment server 118, and an administration system 120. The modules 104 to 120 of the transaction system can be connected to equipment 122 of a remote user via a communications network 124. The user equipment 122 may be any one of a variety of communications devices, such as a telephone, an interactive television, a desktop computer, or a mobile device such as a portable computer, personal data assistant (PDA) or a cellular telephone. The communications network 124 may include the Internet, wireless telecommunications networks and/or local area networks.

In the described embodiment, the modules 104 to 120 of the transaction system are implemented as software modules executed by standard computer systems and stored on non-volatile storage associated with those systems. For example, the web server 104 and WSP modules 106 can be provided on a single computer system 102 with the remaining modules 108 to 120 each provided on its own computer system. The computer systems for the server components 102 to 118 can be Hewlett Packard DL760 servers with 6 550 MHz Pentium III Xeon™ processors and 1 GB of random access memory. The administration system 120 can be provided on a standard personal computer, such as an Intel x86-based personal computer. The web server module 104 is a standard web server such as Microsoft IIS. The modules 106 to 120 of the transaction system are implemented as Java software modules, and provide an object oriented system for processing events and bids for event outcomes as software objects. The WSp module 106 is a Java software module that provides an interface between the IBM WebSphere MQ protocol used to communicate with the Java modules and the Component Object Model (COM) interface of the active server pages (ASP) used by the web server module 104. However, it will be apparent that a number of the components or parts thereof can alternatively be implemented by dedicated hardware components such as application-specific integrated circuits (ASICs).

The transaction system provides an interactive market for registered users, also referred to as members, to place bets on the outcomes of events. An event represents an occurrence that will result in exactly one of a set of two or more definitive outcomes when the event is determined. The time at which an event is officially ruled to have resulted in a particular outcome is referred to as event determination or resolution. A coupon is the basic trading unit of the transaction system and represents a particular outcome for a particular event. A coupon has a set value if the event outcome occurs, and no value if that event outcome does not occur. Another type of coupon is a counter coupon, which corresponds to a standard coupon, and has the set value if the event outcome does not occur and no value if the event outcome does occur. In other words, a coupon is a certificate that entitles its owner to a payment, say $1, if it stipulates the correct outcome of an event, and entitles the holder to nothing if it does not. The coupons can therefore be considered to represent binary options having two possible values. Coupons are only created by the transaction system when a member's bid to buy or sell one or more coupons is matched by one or more bids placed by other members. Once created, the coupons can then be bought and sold through the transaction system at a price, or odds, to be determined by supply and demand. The actual set or face value of the coupon never alters, and is described hereinafter as being $1. The transaction system can be configured to trade in a variety of currencies, including English pounds and U.S. dollars. The bids seen by a member are converted into that member's preferred currency, as indicated by the member's profile data stored in the database 114. Similarly, bids placed by a member are converted from the member's preferred currency, if necessary. The transaction system is able to establish an interactive trading market for the coupons as described below.

Many basic features of the transaction system are described in Intenrnational Patent Application PCT/AU00/00811, which is incorporated herein by reference. The transaction system described in PCT/AU00/00811 primarily addressed events with two possible and mutually exclusive outcomes, whereby the sum of the probabilities of the outcomes or the sum of prices added to unity. In such cases, the outcome represented by a coupon A has a countercoupon A′ which could also be called B, in which case B′ equals A.

The transaction system of the present application is based on the transaction system described in PCT/AU00/00811, and is able to handle events with more than two outcomes Accordingly, basic details of membership, placing of buy and sell bids, payments, and so on, are not described further herein unless they specifically relate to multiple outcome events. The transaction system has application to financial, commodities, gambling and any other market where dependent outcomes can be derived.

In events of N possible outcomes (for N>2), the several possible outcomes are dependent in a more complex way than for binary outcome events. For every outcome of an event, there is an opposite outcome. Accordingly, a positive outcome can be considered as having an opposite negative outcome, and of course a negative outcome an opposite positive outcome. A positive outcome can be thought of as an outcome that is expressed positively, i.e., that a particular outcome will occur, such as “A will win the race”, whereas a negative outcome is expressed negatively, as in “A will not win the race and on of the other runners will”. Another example of a positive outcome is “A will lose the race” and the corresponding negative outcome is “A will not lose the race and one of the other runners will”. The outcomes nominated by Coupons used in the transaction system can be considered as positive outcomes. Accordingly, a bid against a positive outcome is equivalent to a bid for the corresponding negative outcome and is also equivalent to a bid for all positive outcomes other than the nominated positive outcome.

Each outcome can be associated with “for” type and “against” type Coupons. A “for” coupon for a nominated outcome represents that outcome, whereas an “against” coupon for the same nominated outcome represents the opposite of the nominated outcome. An against Coupon can be considered to represent all the positive outcomes except the nominated positive outcome, and can also be called a Counter-Coupon. Accordingly, a “for” coupon is worth its face value if the event outcome is the coupon's stated outcome, whereas an “against” coupon is worth its face value if the event outcome is the opposite of the coupon's stated outcome. The transaction system creates and cancels coupons, with each Coupon having a face value of a fixed amount, say $1. The construction of a Coupon for A and CounterCoupon for A′ (or against A) is similar to the binary two-outcome case, S but in the case of an event with n positive outcomes (labelled A, B, C, . . . ) A′ does not represent B. Rather, A′ represents the sum of the other (n−1) possible Coupons.

Coupons can be traded at market value. A Bid is an offer to trade Coupons, and has attributes such Buy/Sell, Coupon type, outcome, price and quantity. Members of the transaction system can place Buy and Sell Bids on each of the n Coupons and n Counter-Coupons by using equipment 10 such as a telephone or personal computer equipped with web browser software to access the engine server 112 via the web server 104, or by otherwise having a another party (usually a betting operator) to do so on its behalf. Bids submitted to the system are stored in the database 114. Bids can be viewed by users of the system by viewing bid list web pages dynamically generated by the bid display server 108 using bid data received from the engine server 112, as described below.

A Counter Coupon for outcome i is equivalent to the union of Coupons for each outcome except i. This enables the transaction system to provide an exchange service to its customers, whereby they can exchange, for no charge, any Counter Coupon for all the other Coupons except for the outcome of the Counter Coupon, or vice versa. This enables the user to trade each outcome separately, or together, as the user desires.

Users can also Sell complete sets of outcomes back to the transaction system, or Buy complete sets of Coupons from the system for $1. They can also Buy and Sell sets of Counter Coupons to and from the system for a price determined as $1 less than $1 times the number of Coupons in the set. An against coupon can be substituted for the corresponding set of for coupons, and vice-versa.

Likewise, for and against coupon pairs can be traded with the system for the price of $1. This is equivalent to converting the Against coupon to all the For coupons other than the For coupon that is the opposite of the Against coupon, and it is the same as buying a set of For coupons as described above.

The use of Counter Coupons allows the set of Coupons to be bundled together and traded together. At the expense of increased processing overhead in the system, the concept can be expanded to allow any combination of Coupons to be traded as a unit. This also allows the system to be used in the trading of stepped-outcome events such as Team A to win by one goal, or two goals, or three goals, and so on.

Users of equipment 122 can access the transaction system via the communications network 124 and create, review, modify, and delete bids for outcomes of events registered with the transaction system. Communications between the modules of the system and the remote user equipment 122 are provided by the web server module 104. The bid server 110 receives user requests to create, modify, or cancel bids. The bid server 110 also handles administrator requests, such as requests to create a new event or to modify or delete an existing event previously registered with the system. The engine server 112 is the heart of the transaction system and is responsible for determining matches between incoming bids from the bid server 110 and bids previously posted on the system. When a match is found, the coupon server 116 completes the actual trade. A trade is the moving around of money and Coupons to satisfy the matching conditions of the Bids within a match.

One preferred method of operating the transaction system is to match up Member-to-Member bets, and never actually take a stake in the outcome of an event, in which case the transaction system creates, removes, and transfers Coupons in any way, as long as the net result is at no cost or profit to the system. A Coupon can be thought of as a bet against the system, but because the system matches all sides of a bet in a match with other users, the net result is a bet against another person or other people. This means that Coupons can be transferred from one user to another user. A Coupon can be created or removed in a Coupon and Counter-Coupon pair for and against same outcome, respectively. Also, Coupons can be created and removed across all positive or all negative outcomes if they are all Buys or all Sells. They may also match in more complicated ways, as described below.

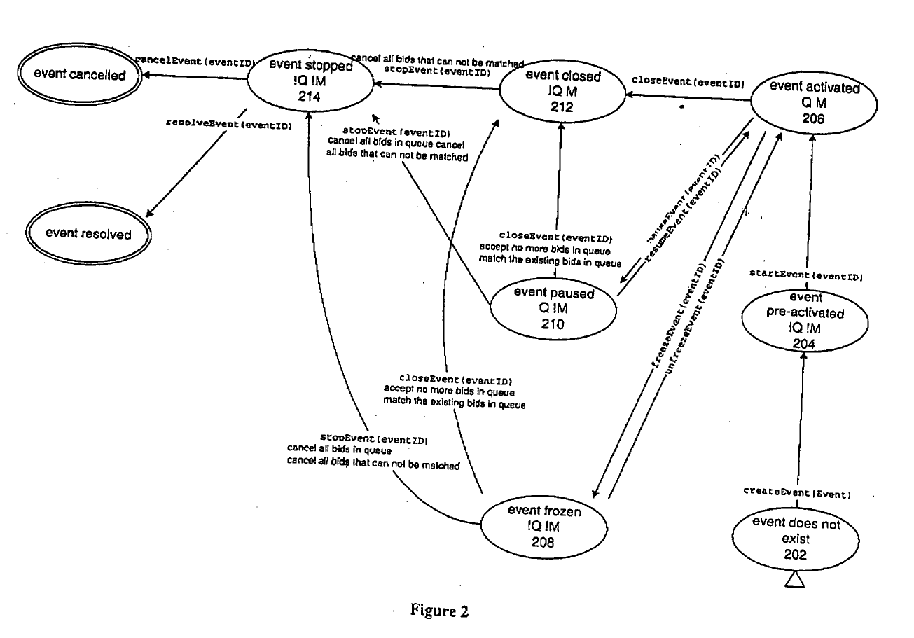

The administration system 120 is provided to allow an administrator of the transaction system to perform various administration tasks, such as entering event resolution data, and pausing, freezing and unpausing, unfreezing events. A state diagram for event objects is shown in FIG. 2. An event object can be created from the null state 202 by the CreateEvent(Event) method, leading to the event pre-activated state 204. The state of event queuing can be represented by the letter Q, where Q indicates that the system is accepting and queuing bids, and !Q indicates that the system is not accepting bids in the queue. Similarly, the letter M indicates that matching is enabled in the engine server 112, whereas !M represents that matching is disabled. In the preactivated state 204, both queuing and matching are disabled. However, these can be enabled by the StartEvent method placing the object in an activated state 206. Both queuing and matching can be disabled by invoking the FreezeEvent method, leading to the frozen state 208. This can be reversed by the UnfreezeEvent method. Alternatively, the event can be paused by the PauseEvent method, leading to the paused state 210. In the pause state, queuing is enabled, but matching is disabled. The CloseEvent method puts the event in the closed state 212, where queuing is disabled but matching remains enabled, to allow bids already received by the system to be processed, whilst preventing further bids from being queued. The event can be put in a stopped state 214, by the StopEvent method in which queuing and matching are disabled. An event can be cancelled all together by the CancelEvent method, or resolved by the ResolveEvent method.

Each event has a number of times associated with it, including a start time with the event in the preactivated state 204, a trade start time when the event enters the activated state. 206, a trade in time, where the event enters the event closed state 212, and an event end time, where the event enters the event stop state 214. At the event end time, all bids remaining in the engine server 112 are cancelled. Upon event resolution, the coupons for that event are processed by the coupon server 116. Coupons corresponding to the resolved outcome are deleted and their value credited to the user's account. Coupons with other outcomes are deleted from the database 114.

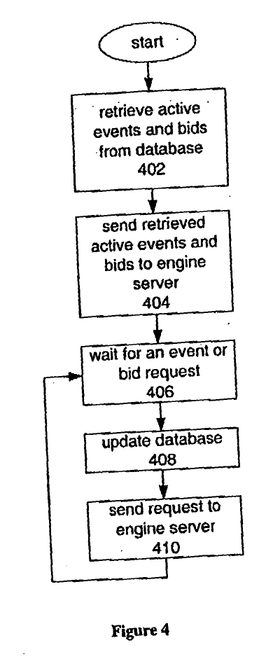

The bid server 110 executes a bid server process, as shown in FIG. 4. When the process begins executing, the bid server 110 retrieves all active events and bids from the database 114 at step 402. These are sent to the engine server 112 for processing at step 404. The bid server 110 then waits for a new event or bid request at step 406. For example, a user of equipment 122 can create a request to create a new bid for a particular event outcome, modify an existing bid previously posted by the user, or delete an existing bid. Alternatively, an administrator of the system can use equipment 122 to issue a request to create, modify, or delete an event. When a request is received, the bid server 110 updates the database 114 at step 408 to ensure that the request is reflected in the database 114 by creating new bid or event entries in the database 114, or modifying or deleting existing entries. At step 410, the event or bid request is sent to the engine server 112 for processing. The bid server process then returns to step 406 to wait for another request.

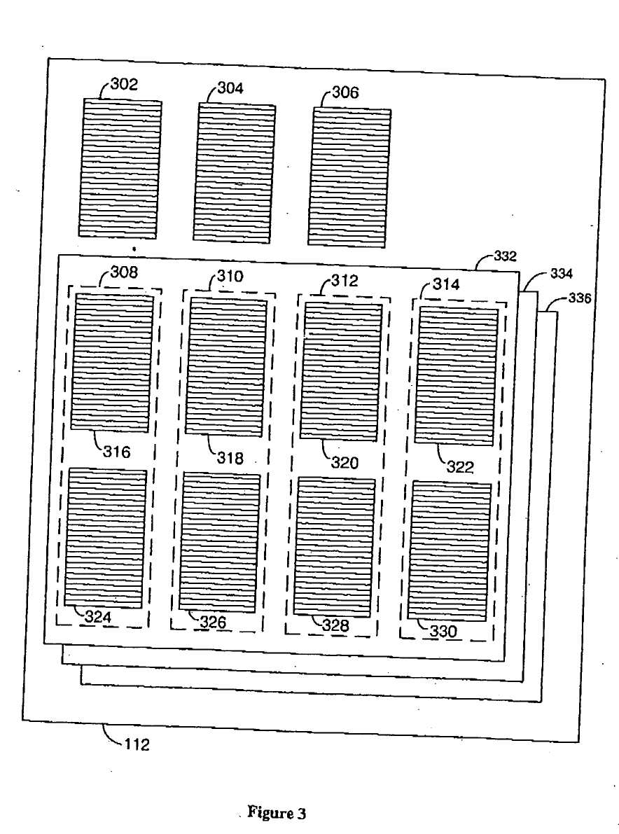

As shown in FIG. 3, the engine server 112 generates and maintains a number of stack-like data structures or lists for each active event, including a first-in-first-out request queue 302 for incoming requests received from the bid server 110, a bid identifier list 304 that provides a sorted list of all bid identifiers for bids posted by the engine server 112, and an expiry list 306 that provides the expiry time for each active event in the engine server 112, sorted by expiry time.

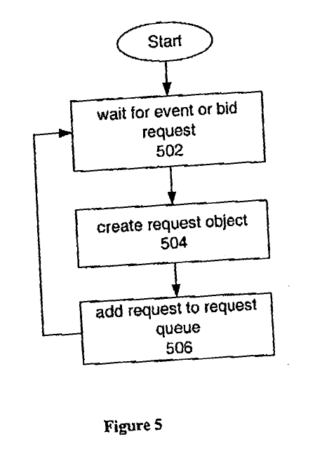

The engine server 112 provides a number of execution threads. A request queuing thread process, as shown in FIG. 5, processes event and bid requests received from the bid server 110. When the process begins, it waits to receive a bid or event request, at step 502. When a request is received, a request object is created at step 504 , and is added to the request queue 302 at step 506. The request queuing process then returns to wait for the next request at step 502.

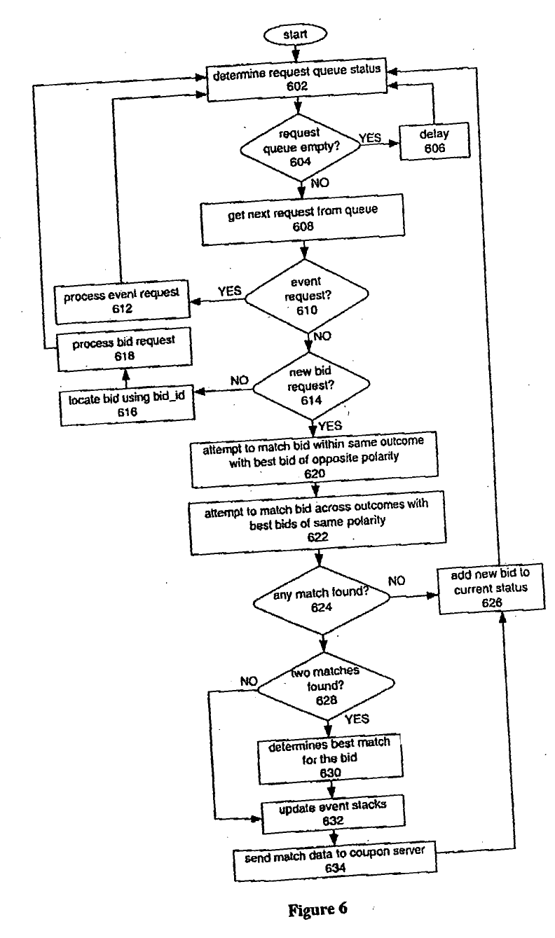

A request process, as shown in FIG. 6, begins by determining the status of the request queue 302 at step 602. If, at step 604, it is determined that the request queue is empty, then the process delays for a short period at step 606, before returning to step 602 to check the queue status again. Alternatively, if the request queue is not empty, then the next request is removed from the queue 302 at step 608. If, at step 610, it is determined that the request is a request to create, modify or delete an event, then the request is processed at step 612. If the request is to create a new event, then the event lists for that event are generated. Otherwise, the event is modified or deleted, as appropriate. After processing the request, the process returns to step 602 to check for further queue entries. If the request was not an event request, a test is performed at step 614 to determine whether the request is to create a new bid. If not, then the request is to modify or delete an existing bid, and at step 616 the bid identifier of the bid to which the request relates is used to identify the bid lists for that event using the bid identifier list 304. At step 616, the bid request is processed, which involves either modifying data of the bid, or deleting the bid from the system. The process then returns to step 602 to check for the next request in the queue.

If, at step 614, it is determined that the request is to create a new bid, then the engine server 112 attempts to match the new bid. For matching purposes, a bid is characterised as either a positive bid, representing a “buy for” or “sell against” bid, or a negative bid, representing a “sell for” or “buy against” bid. A Bid against an outcome can be translated to a Bid for an outcome by reversing the Buy/Sell attribute, and taking the price as $1—the Real Bid price. This can be done because the user's position (and therefore the transaction system's position) is identical whether the user places the “against” Bid, or the “translated for” Bid.

The engine Server 112 maintains 2n bid lists for an event with n positive outcomes. For each positive outcome, there is a positive list for ‘Buy for’ and ‘Sell against’ Bids, and a negative list for ‘Buy against’ and ‘Sell for’ Bids. Accordingly, there are 2n types of Coupons (n “for” type, and n “against” type), resulting in 4n possible types of Bids (Buy and Sell for each type of Coupon). For example, an event with four positive outcomes A, B, C, and D is represented by a set 332 of eight bid stacks 316 to 330, two for each positive-negative outcome pair, as shown in FIG. 3. Each event has a positive outcome bid list and a negative outcome bid list. For example, the lists 308 for outcome A include a positive outcome bid list 316 and a negative outcome bid list 324. Each list contains entries for individual bids, sorted by price. The positive bid lists are sorted with the highest price at the top of the list, while the negative lists are sorted with the lowest negative bid at the top of the list. This arrangement facilitates bid matching, as the highest positive bid is always the best positive bid; whilst the lowest negative bid is the best bid of that type. This facilitates the identification of the most matchable Bid at any given time from a given Bid list. The most matchable Bid is the only Bid from that Bid list that the engine server 112 needs to check for matches against, until either it is matched, or a more matchable Bid enters the system.

As each Bid enters the engine server 112, it is first checked for possible matching against the existing Bids, and any unmatched portion is then inserted into the correct list for matching when other Bids enter the system.

Matching can occur in two main ways:

(i) Within the same positive-negative outcome pair:

This is the simplest form of a match. It occurs when the best Buy Bid is greater than or equal to the best Sell Bid. Coupons are simply transferred from the Seller to the Buyer and the money is transferred in the opposite direction. Note that, due to the translation described above, this may in fact have been a match between a Buyer of ‘for’ Coupons, and a Buyer of ‘against’ Coupons, in which case the system creates the required Coupons on both sides; or a match between a Seller of ‘for’ Coupons, and a Seller of ‘against’ Coupons, in which case the system removes the Coupons on both sides.

(ii) Across all outcomes:

This match occurs either:

(a) when the best Buy Bids on all outcomes of the same type total to at least $1.
Outcomes with no Buy Bids are taken to have a Bid of $0 on them; or

(b) when the best Sell Bids on all outcomes of the same type total to at most $1,
Outcomes with no Sell Bids are taken to have a Bid of $1 on them.

Once again, this type of match may in fact include Buys and Sells of ‘against’ Bids, because of the translation described above.

In the description below, the following terminology is used:

Mᵢⱼ denotes a Member Bid for Coupon i,

where Mᵢⱼ is a Member Buy Bid if j=b, or a Member Sell Bid if j=s, and:

M_{i′j} denotes a Member Bid for Counter Coupon i′
   For simplicity, the “volume” of each Bid is assumed to be unity, and the Bid Mᵢⱼ can be read as a Bid of a certain price, in which case the statement that Mᵢⱼ is greater than M_{bj} means that the Price of Bid Mₐⱼ is greater than the price of Bid M_{bj}.

Returning to FIG. 6, an attempt is made to match the bid within the same outcome pair, at step 620. For example, a bid to buy a coupon for outcome B of the event represented by bid lists 332 is a positive bid that, if partially or completely unmatched, would be inserted into the positive list 318 for outcome B. Accordingly, an attempt is made to match the new bid with the best negative polarity bid for outcome B′ in the negative list 326 for outcome B″.

The engine server 112 determines a match within the same outcome when:

(i) a Member Buy Bid for Coupon i is greater than or equal to the minimum of:
(a) a Member Sell Bid for Coupon i; and
(b) unity minus a Member Buy Bid for Coupon i′;
i.e.,
   M_{ib}≧min(Mᵢₛ, 1−M_{i′b}); or

ii) a Member Sell Bid for Coupon i is less than or equal to the maximum of:
(a) a Member Buy Bid for Coupon i, and
(b) unity minus a Member Sell Bid for Coupon i′;
i.e.,
   Mᵢₛ≦max(M_{ib}, 1−M_{i′s}).

At step 618, an attempt is made to match the bid with the best bid of the same ‘polarity’ across outcomes for the event. The engine server 112 determines a match across all outcomes when:

(i) a Member Buy Bid for Coupon z is greater than or equal to unity minus the sum of the greater of Member Buy Bids and unity minus Member Sell Bids on the corresponding Counter Coupons, for each outcome except z; i.e.,
M_{zb}≧1−Σ_{[z]}max(M_{ib},1−M_{i′s}); or

(ii) a Member Sell Bid for Coupon z is less than or equal to unity minus the sum of the lesser of Member Sell Bids and unity minus Member Buy Bids on the corresponding Counter Coupons, for each outcome except z′; i.e.,
M_{zs}≦1−Σ_{[z]}min(Mᵢₛ,1−M_{i′b}),

where Σ_{[z]} denotes the sum over all Coupons except z, noting that M_{ib} and ΣM_{[i′]s} are equivalent in terms of outcomes, but are probably not equivalent in prices at any given time.

It will be apparent that the classification of events into ‘positive’ (buy for and sell against) and ‘negative’ (buy against and sell for) categories simplifies the matching process, as the matching across outcomes matches bids of the same polarity. The engine server 112 first determines whether an incoming bid is a positive bid or a negative bid. For example, referring to FIG. 3, if the bid is a positive bid for outcome B, corresponding to the second bid list 318, then the engine server 112 attempts to match the incoming bid with the best positive bids of the other positive lists 316, 390, 322 for outcomes A, C, and D. Because these lists are stored, the best positive bids are always found at the top of a positive list. Alternatively, if the bid is a negative bid for outcome B′, then the engine server 112 attempts to match the bid with the best bids in the remaining negative lists 324, 328, 330 for negative outcomes A′, C′, and D′. Because the negative lists are sorted in ascending order, the best negative bids are always found at the top of the negative lists.

For example, the new positive bid for outcome B and the best positive bids for the remaining outcomes A, C and D can be used to generate a match. Specifically, the new positive bid for outcome B is added to the best positive outcome bids on the top of the positive bid lists 316, 320, and 322 for outcomes A, C, and D, respectively, are added together to produce an aggregate bid corresponding to any of the possible outcomes. Consider the case where these bids are 12 cents, 20 cents, and 30 cents, respectively, and the new positive bid for outcome B is 40 cents. The sum of these bids for all outcomes is 12+40+20+30=102 cents. As this is more than the $1 cost of a coupon, the system can accept the bid and generate a coupon, with a margin of 2 cents. Alternatively, if the new positive bid for B is 40 cents, and the best (i.e., lowest), bid at the top of the negative list 326 for outcome B was 39 cents, then a coupon trade can take place, with a margin of 1 cent.

At step 624, a test is performed to determine whether any matches were found. If not, then the new bid is simply added to the appropriate list for the event, in this case being the positive list 318 for outcome B. The insertion is performed to maintain the sort order by price of the list 318.

Alternatively, if at least one match was found, then a test is performed at step 628 to determine whether two matches were found. If so, then the match margins are compared to determine the best match for the bid at step 630. For example, in the case above, the bid within outcome B provided a margin of 1 cent for the buyer, whereas the bid matching across all outcomes provided a margin of 2 cents for the bid. Accordingly, the matching of bids across all outcomes provides a higher margin for the bidder, and this bid is therefore used. At step 632, the event lists are updated to reflect the transaction. In the case of a bid with a volume of 1, this would simply be deleting the bid. However, bids are typically for higher volumes, and typically only one of the Bids is completely fulfilled in a match. The residual bid volumes are therefore updated to reflect the transaction and can be subsequently matched with other Bids by the engine server 112. Any unmatched portion of the new bid is inserted into the appropriate queue, being the positive queue 318 for outcome B in this case.

At step 634, the match information is sent to the coupon server 116 for processing. The request process then returns to check the request queue for further requests at step 602.

The coupon server 116 is responsible for the processing of coupons in response to matches. This includes generating any destroying coupons, and adjusting user coupon and account data, stored in the database 114.

The bid display server 108 generates a live view of the bids in the engine server 112. Event and bid data, including quantity, price, event, outcome, whether buy/sell, or for/against are received from the engine server 112, and used to generate a dynamic web page that is sent to the user's equipment 122 via the web server 104 and communications network 124. The bid display server 108 aggregates individual bids with the same characteristics to provide a convenient summary for the user. In particular, the bid display server 108 generates arbitrage bids for display to the user. These are generated in response to a user request for display of bid data from the system.

Matching only takes place between sets of Member Bids. Arbitrage Bids are a device used to invite Member Bids that will cause matches. An Arbitrage Bid is not a Real Bid, but represents the same betting opportunity as a Real Bid or set of Real Bids. Arbitrage Bids cannot be matched with Arbitrage Bids, but are a form of “mirror image” of a Member Bid or set of Member Bids. When a new Member Bid is posted that appears to “match” an Arbitrage Bid, the Member Bid is actually matching with an existing Member Bid or set of Member Bids.

Sᵢⱼ denotes an Arbitrage Bid for Coupon i placed by the engine server 112, where Sᵢⱼ is an Arbitrage Buy Bid if j=b, or an Arbitrage Sell Bid if j=s. S_{i′j} denotes an Arbitrage Bid for Counter Coupon i′.
S_{ib}=Arbitrage Buy Bid on the i Coupon=Max (1−R_{i′s}, 1−Σ_{[j]}(max_{k≠i})R_{k′b}, 1−R_{k′s}))),

where R_{i′j} represents Real Coupon Bids (i.e., sell bids placed by members) for coupons other than coupon i (a Buy Bid if j=b, or a Sell Bid if j=s).

The following terms are similarly defined:
Sᵢₛ=Arbitrate Sell Bid on the i Coupon
S_{i′b}=Arbitrage Buy Bid on the i Counter Coupon
S_{i′s}=Arbitrage Sell Bid on the i Counter Coupon

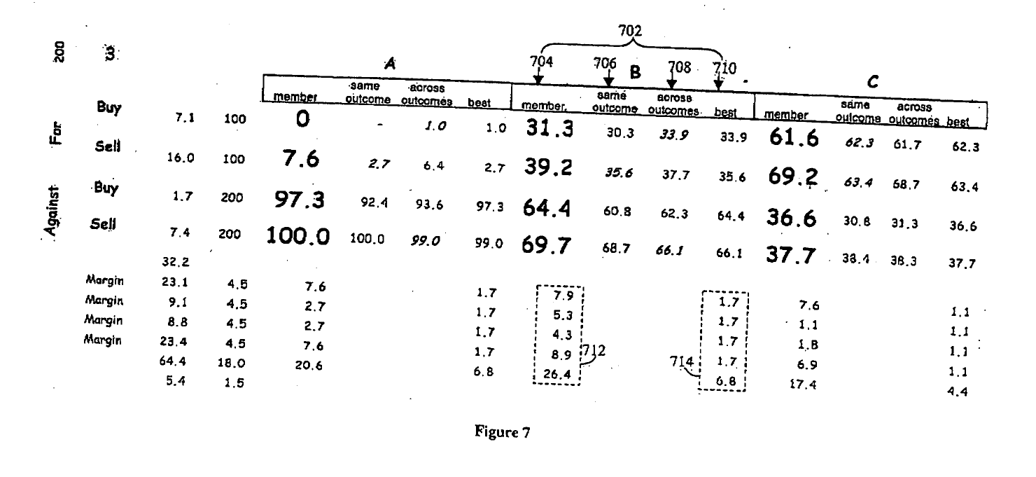

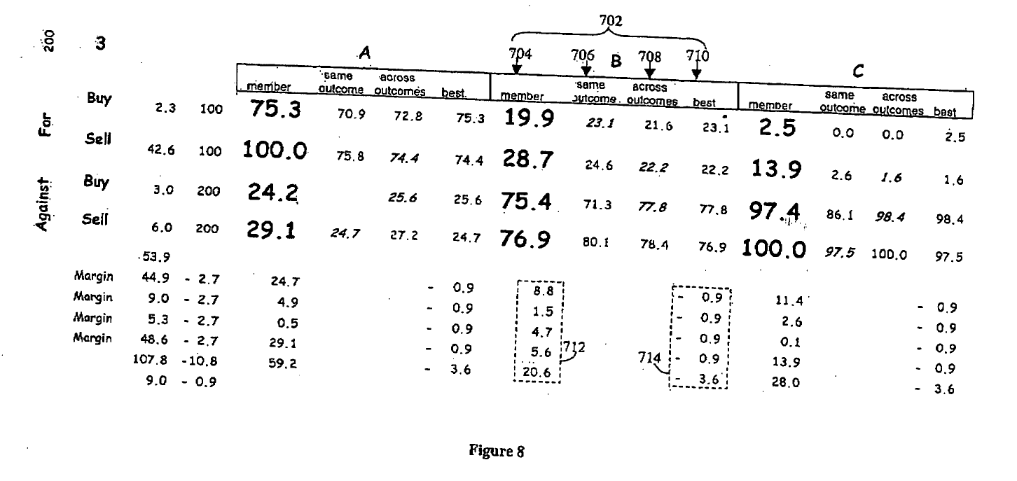

FIGS. 7 and 8 provide examples in which Arbitrage Bids are shown generating significant reductions in the margins for an event with three outcomes A, B, and C, as compared with margins without taking into account such Arbitrage Bids. The column for each outcome is itself divided into three bid columns. Considering the column 702 for outcome B in FIG. 7, and moving from left to right, a first column 704 provides member bids, a second column 706 provides the corresponding bid generated within the same outcome, a third column 708 provides the corresponding bid across all outcomes, and a fourth column 710 provides the best of the three bids in the other columns 704 to 708; i.e., the arbitrage bid that is displayed to users of the transaction system.

The margins 712 resulting from conventional bid matching are shown below the bids, while margins 714 resulting from the best bids are shown below the optimum bid column 710. While the best margin available by conventional matching is 4.3 (corresponding to a comparison between the 31.3¢ member buy for bid for outcome B in the first column 704 and the sell for bid of 35.6¢ in the second column 706, which is a translation of the member buy against bid of 64.4¢ in the first column 704).

FIG. 8 illustrates how the engine server 112 can generate matches where conventional matching would not match at all. In this case, none of the member buy offers are equal to or greater than their corresponding sell offers. However, the sell against member bid of 76.9¢ for outcome B is translated to a buy for bid for outcome B at a price of 100¢−76.9¢=23.1¢. The sum of this translated bid with the buy for member bids of 75.3¢ and 2.5¢ for outcomes A and C, respectively, is equal to 100.9¢. As this exceeds the $1 cost of generating a coupon, the system can match these the two buy for bids and the sell against bid, generating coupons for outcomes A and C, and destroying the coupon for outcome B.

The match described above can also be viewed in other ways. For example, the buy against bid generated across outcomes by the engine server 112 for outcome B in the third column 708 has a value of 77.8¢, corresponding to the sum of the member buy for bids for outcomes A and C. This is because a combination of buy for bids for outcomes A and C is equivalent to a buy against bid for outcome B. Because the bid generated is greater than the member sell against bid of 76.9¢ in the first column 704, the two bids are matched, with a margin of 76.9¢−77.8=0.9¢. If the transaction system is operated in the preferred method whereby margins benefit the most recent matching bid, the benefit is provided to the member that made the most recent of the three bids involved in the match.

It will be apparent that the system can also be used with events with continuously variable outcomes or a large number of outcomes by defining discrete categories for the outcomes. For example, the value of a stock or share can be bet upon by defining a number of categories such as a bet that by a stock value at 3 pm will be between (a) $1 and $1.10, (b) $1.10 and $2, (c) $2 and $3, or (d) more than $3. Of course, bets can also be placed that the stock value will not be between $1 and $1.10, or not between $1.10 and $2, and so on.

The transaction method and system described herein is applicable to betting and any financial or other market which can be formulated as a set of discrete outcomes, which can include practically every market using suitable categories.

Many modifications will be apparent to those skilled in the art without departing from the scope of the present invention as herein described with reference to the accompanying drawings.

1. A transaction method, including;
receiving bids for coupons at prices less than a predetermined value, each coupon representing an outcome of an event having more than two outcomes, the coupon having said predetermined value if said outcome occurs and no value if said outcome does not occur;
generating bid data representing buy and sell bids for and against each outcome of said event on the basis of the received bids; and
determining a match between received bids on the basis of the generated bid data.

2. A transaction method as claimed in claim 1, including
issuing one or more coupons for respective buy bids of said match; and
decreasing one or more accounts in respect of said buy bids.

3. A transaction method as claimed in claim 1, including
destroying one or more coupons for respective sell bids of said match; and
increasing one or more accounts in respect of said sell bids.

4. A transaction method, including:
receiving a bid for at least one coupon at a price less than a predetermined value, said coupon representing an outcome of an event having more than two outcomes and having a predetermined value if said outcome occurs and no value if said outcome does not occur; and
attempting to match said bid with bids for coupons representing outcomes of said event other than said outcome.

5. A transaction method as claimed in claim 4, including
attempting to match said bid with a bid for one or more coupons representing the non-occurrence of said outcome for said event; and
selecting the best match for said bid.

6. A transaction method as claimed in claim 4, including determining a match of a bid for a coupon representing outcome z if:
(i) M_{zb}≧1−Σ_{[z]}max(M_{ib} ,1−M_{i′s}), or
(ii) M_{zs}≦1−Σ_{[z]}min(Mᵢₛ ,1−M_{i′b}),
where M_{ib} is a buy bid for at least one coupon representing outcome i, Mᵢₛ, is a sell bid for at least one coupon representing outcome i, and Σ_{[z]} denotes a sum over all bids for coupons except bids for coupons representing outcome z.

7. A transaction method as claimed in claim 5, including determining a match of a bid for a coupon representing outcome z if:
(i) M_{zb}≧min(M_{zs} ,1−M_{z′b}), or
(ii) M_{zs}≦max(M_{zb} ,1−M_{z′s}),
where M_{zb} is a buy bid for at least one coupon representing outcome z, M₂₅ is a sell bid for at least one coupon representing outcome z, and z′ denotes an outcome opposite to outcome z.

8. A transaction method as claimed in any one of the preceding claims, including generating a bid for display to a user, said bid being a buy bid S_{ib} for a coupon representing outcome i, according to:
S_{ib}=Max(1−M_{i′s}, 1−Σ_{[i]}(max_{k≠i}(M_{k′b}, 1−M_{k′s}))),
where M_{i′s} represents an existing buy bid for at least one coupon representing an outcome opposite to outcome i, and Σ_{[i]} denotes a sum over all bids for coupons except bids for coupons representing outcome i.

9. A transaction method, including:
maintaining lists of buy and sell bids for and against outcomes of an event having more than two outcomes;
receiving a bid for at least one coupon at a price less than a predetermined value, said coupon representing an outcome of said event and having a predetermined value if said outcome, occurs and no value if said outcome does not occur, and
matching said bid with bids of said lists representing outcomes other than said outcome

10. A transaction method as claimed in any one of claims 1 to 6, wherein said coupons include coupons for outcomes and coupons against outcomes.

11. A transaction method as claimed in any one of claims 1 to 6, wherein said outcomes include positive outcomes and negative outcomes.

12. (canceled)

13. A transaction system having components for executing the steps of any one of claims 1 to 11.

14. A computer readable storage medium having stored thereon program code for executing the steps of any one of claims 1 to 11.

15. (canceled)

16. A transaction system, including:
a server for receiving bids for coupons at prices less than a predetermined value, each coupon representing an outcome of an event having more than two outcomes, the coupon having a predetermined value if said outcome occurs and no value if said outcome does not occur,
a transaction engine for generating bid data representing buy and sell bids for and against each outcome of said event on the basis of the received bids; and
determining a match between received bids on the basis of the generated bid data.

17. A transaction system as claimed in claim 16, including a bid display server for generating arbitrage bids providing reduced margins for display to a user of said system to encourage said user to place a bid with said system.

18. A transaction system for establishing a trading market for coupons representing outcomes for an event having more than two outcomes.
